(19) United States
(12) Patent Application Publication
(10) Pub. No.: US 2014/0236389 A1
(43) Pub. Date: Aug. 21, 2014

(54) SYSTEM AND METHOD OF DYNAMICALLY MODIFYING A USER INTERFACE BASED ON SAFETY LEVEL

(71) Applicants: Krystal Rose Higgins, Sunnyvale, CA (US); Eric J. Farraro, San Jose, CA (US); John Tapley, Santa Clara, CA (US)

(72) Inventors: Krystal Rose Higgins, Sunnyvale, CA (US); Eric J. Farraro, San Jose, CA (US); John Tapley, Santa Clara, CA (US)

(73) Assignee: eBay Inc., San Jose, CA (US)

(21) Appl. No.: 13/769,519

(22) Filed: Feb. 18, 2013

(51) Int. Cl. G06F 17/00

(52) U.S. Cl. CPC G06F 17/00
USPC 701/2; 701/36

(57) ABSTRACT

A method of dynamically altering a user experience based on safety level is provided. A first user experience is provided to a user in a vehicle. The information is received from an information source. The information is used to calculate a safety level score for a vehicle. Then, a second user experience different than the first user experience is provided to the user in the vehicle, based on the safety level score.

### BACKGROUND

User experience is a broad term covering many aspects of experiences of users with computing products or services accessed through the computing products (such as web sites). The user experience includes not only the user interface, but also the graphics and physical interaction. Recently, it has been more common for users to utilize electronic devices in moving vehicles, as in for example automobiles. The user interface may be displayed on an in-dash computer screen or may be located on a smartphone, which may be carried or may be physically mounted on a dashboard of the vehicle, for example. For the most part, the user experience with these in-vehicle electronic devices is somewhat static in nature. The user interface (UI) screens displayed are the same no matter the state of the vehicle. While some automobiles automatically deactivate particular element of such UIs while the vehicle is in motion, and only allow the element to be activated when the vehicle is stopped and in “park,” the decision is simply “on/off”—if the car is in motion, the element is disabled.

### BRIEF DESCRIPTION OF DRAWINGS

FIG. 1 is a network diagram depicting a client-server system, within which one example embodiment may be deployed.

FIG. 2 is a diagram illustrating a progression, in accordance with an example embodiment, of dynamic alteration of a user interface based a calculated safety level.

FIG. 3 is a diagram illustrating a progression, in accordance with another example embodiment, of dynamic alteration of a user experience.

FIG. 4 is a diagram illustrating a system, in accordance with an example embodiment.

FIG. 5 is a diagram illustrating a table of user experience presentations in accordance with an example embodiment.

FIG. 6 is an interaction diagram illustrating a method, in accordance with example embodiment, of dynamically altering a user experience.

FIG. 7 is an interaction diagram illustrating a method, in accordance with another example embodiment, of dynamically altering a user experience.

FIG. 8 is an interaction diagram illustrating a method, in accordance with another example embodiment, of dynamically altering a user experience.

FIG. 9 is a flow diagram illustrating a method, in accordance with an example embodiment, of dynamically altering a user interface.

FIG. 10 shows a diagrammatic representation of a machine in the example form of a computer system within which a set of instructions for causing the machine to perform any one or more of the methodologies discussed herein may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Although the present embodiments have been described with reference to specific example embodiments, it will be evident that various modifications and changes may be made to these embodiments without departing from the broader spirit and scope of the embodiments. Accordingly, the specification and drawings are to be regarded in an illustrative rather than a restrictive sense.

In an example embodiment, various aspects of a user experience are dynamically altered based on motion. Specifically, in one example embodiment, the speed of an electronic device, which may be traveling in a vehicle, may be used to dynamically adjust aspects of the user experience based on a calculated safety level. While there are certain elements of a user interface that a designer may wish to completely disable while a vehicle is in motion, there may be others where it may be permissible to utilize the element under “safe” driving conditions (e.g., low speed, such as in a parking lot, stopped at stop-light but not in park). In addition to the speed of the electronic device, other parameters of motion may be used to aid in the determination of how safe the driving conditions are. For example, acceleration may be used, as a car that is going relatively slow (e.g., 10 mph) but is accelerating rapidly may not be in a “safe” driving condition, while the same car going the same speed without any acceleration may be in a “safe” driving condition. Furthermore, in some example embodiments, other sensor data from a vehicle or electronic device can be used to aid in the determination of how safe the driving conditions are. This may include cruise control information, brake sensor information, steering wheel sensor information, traction control system sensor information, etc.

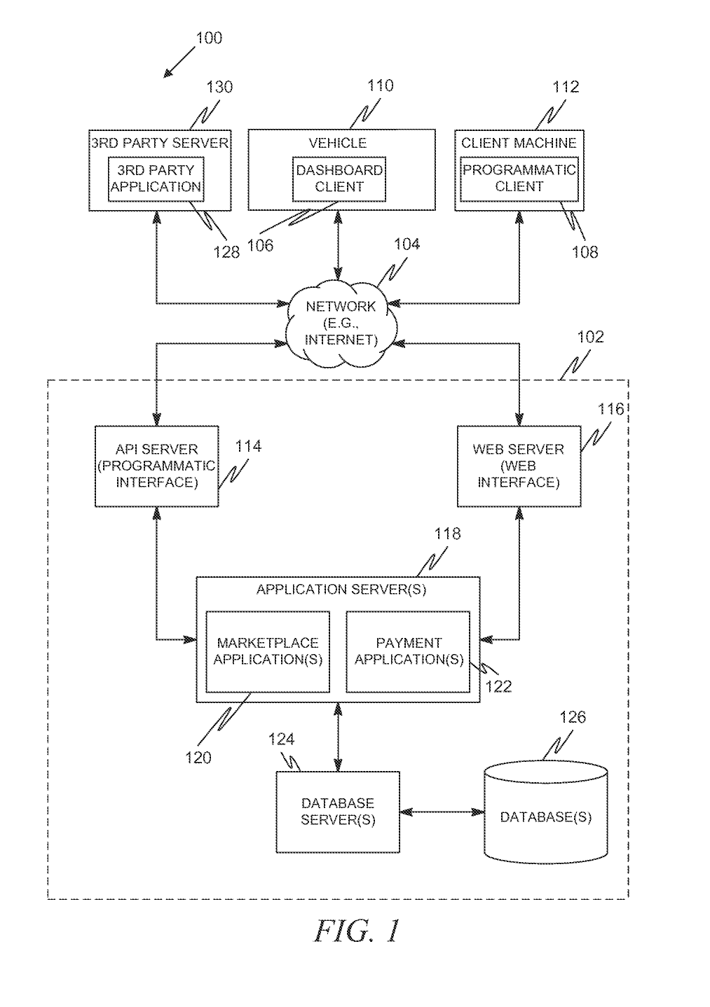

FIG. 1 is a network diagram depicting a client-server system 100, within which one example embodiment may be deployed. A networked system 102, in the example form of a network-based marketplace or publication system, provides server-side functionality, via a network 104 (e.g., the Internet or Wide Area Network (WAN)) to one or more clients. FIG. 1 illustrates, for example, a dashboard client 106 (e.g., software running in a dashboard), and a programmatic client 108 executing on respective machines, namely vehicle 110 and client machine 112.

An Application Program interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The dashboard client 106 accesses the various marketplace and payment applications 120 and 122 via a web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

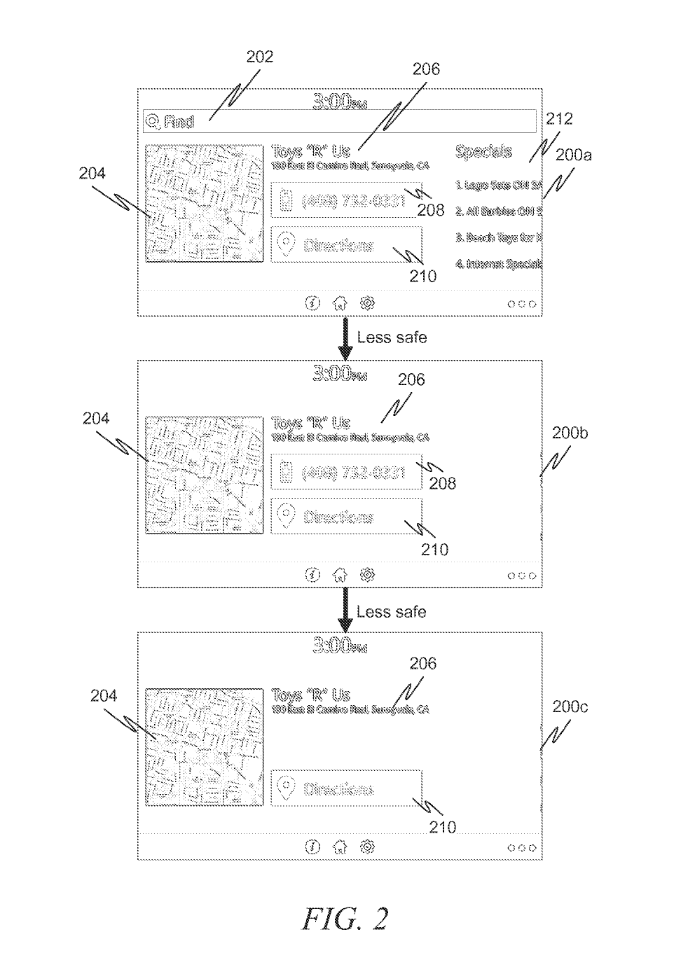

FIG. 2 is a diagram illustrating a progression, in accordance with an example embodiment, of dynamic alteration of a user interface based a calculated safety level. Pictured here are a user interface 200a, 200b, and 200c in three states. The user interface 200a, 200b, or 200c here are displayed on a dashboard display of a vehicle. It should be noted that while a dashboard implementation is depicted, a similar process could run on any electronic device, such as a mobile device. Beginning with the user interface 200a in the first state, it can be seen that the user interface 200a has various sections, including a find area 202, which allows a user to type in a search term, a map 204, a listing result area 206 including a phone number button 208 and a directions button 210, as well as an area 212 listing specials available from a merchant in the listing. Here the user apparently has searched for a toy store, and the results reflect a location, phone number, and other information for the located toy store.

In this state, the user interface 200a may be located on a device that is deemed to be in a “safe” driving condition. For example, a vehicle displaying the user interface 200a may be at a complete stopped and in “park.”

As the user drives the vehicle, the device may ultimately be deemed to be in a “less safe” state, such as where the vehicle is moving at a slow speed. In such an instance, a transition may be made to user interface 200b, where elements of the user interface 200b have been removed to make the user interface 200b simpler for the user, who may not be able to pay full attention to the display. Here, the find area 202 has been removed, as has the area 212 listing specials. By eliminating the find area 202, the user is unable to engage in the act of typing and the selectable elements remaining, including phone number button 208, which causes a phone to dial the stated phone number when depressed, and direction button 210, which causes directions to the identified location to be displayed when depressed, only require a single touch, and thus do not require as much attention from the user as typing would require.

As the user continues to drive the vehicle, the device may ultimately be deemed to be in an even less safe state, such as where the vehicle is moving at high speed. In such an instance, a transition may be made to user interface 200c, where additional elements of the user interface 200c have been removed. Here, the phone number button 208 has been removed, as the system has determined that using a telephone while driving, even using a hands-free device activated by a single button press, may not be safe.

It should be noted that while this example depicts the notion of removing elements as the safety level of vehicle is reduced, other changes to the user interface can be made as well. Changes in size, layout, color, brightness, orientation, and other visual aspects can be made to the user interface to result in a “safer” user interface. For example, small buttons may be increased in size to reduce the amount of time it takes the user to position his or her finger over the button and depress it.

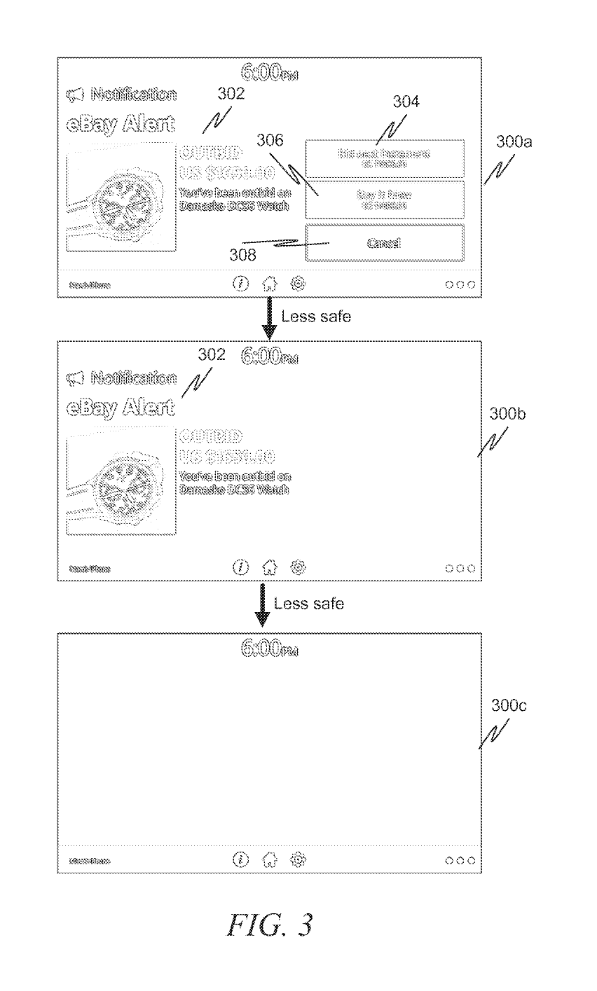

FIG. 3 is a diagram illustrating a progression, in accordance with another example embodiment, of dynamic alteration of a user experience. Here, depicted are three states of a user interface 300a, 300b, and 300c, displaying an auction notification. Essentially, the user has bid on an online auction and been outbid, and the system is attempting to notify the user of the fact that he or she is outbid to see if he or she wishes to rebid. User interface 300a includes a notification 302 as well as a bid next increment button 304, which allows the user to automatically make a bid one increment higher than the highest bid, a buy it now button 306, which allows the user to simply end the auction by purchasing the item at a pre-set price, or cancel button 308, which allows the user to do nothing but dismiss the notification 302. This user interface 300a may be displayed when it is deemed safe enough for the user to do so, based on the various factors described earlier.

As the user drives the vehicle, the device may ultimately be deemed to be in a “less safe” state, such as where the vehicle is moving at a slow speed. In such an instance, a transition may be made to user interface 300b, where elements of the user interface 300 have been removed to make the user interface safer. Here, the buttons 304, 306, 308 have been removed, basically eliminating any possible interaction based on the notification. If the user wishes to increase his or her bid at this point, he or she may, for example, pull over to the side of the road or engage in some other activity that causes the system to recognize that it is in a safer situation, at which point the user interface 300b may revert to 300a. The user interface 300b at the very least provides the notification to the user.

There may be certain conditions, however, where even a notification itself may be unsafe. For example, as the user continues to drive the vehicle, the device may ultimately be deemed to be in an even less safe state, such as where the vehicle is moving at high speed. In such an instance, any notifications may be blocked entirely and the user may simply be presented with a nearly bare screen, such as in user interface 300c. In such instances, incoming notifications may simply be queued and held until such time as the system deems the vehicle to be in a safer situation.

Other aspects of a user experience may be modified in accordance with the processes described herein, and the present disclosure is not limited to changes in the visual user interface 300a, 300b and 300c. For example, sound effects and other audio aspects of the user interface 300a, 300b and 300c can be modified to provide, for example, an audio notification

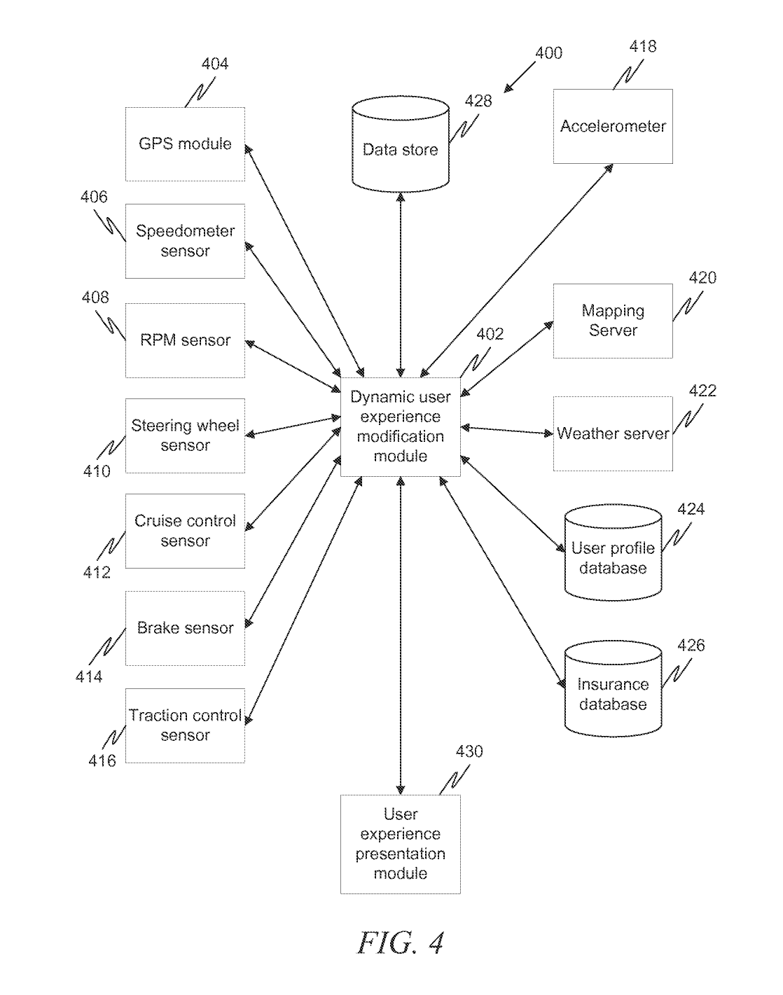

As described above, the modifications to the user experience may not be just merely based on speed. Indeed, various information related to the safety level of the vehicle may be utilized in order to determine how to dynamically modify the user experience. FIG. 4 is a diagram illustrating a system, in accordance with an example embodiment. The system 400 may include a dynamic user experience modification module 402. Coupled to the dynamic user experience modification module 402 may be various information sources and/or sensors 404-426 from which the dynamic user experience modification module 402 may gather information related to the current safety level of a vehicle. These various information sources and/or sensors 404-426 may be located in a vehicle, in a mobile device travelling in the vehicle, or outside the vehicle. Presented here are a number of examples of these information sources and/or sensors 404-426, but the disclosure is not limited to the examples provided. Additionally, not all embodiments will contain each of these information sources and/or sensors 404-426, and in fact some embodiments may rely on a single information source and/or sensor 404-426 (such as, for example, one that provides speed information). Indeed, certain types of information may be gathered from various alternative mechanisms. As an example, speed information could be gathered from examining a GPS module 404 over time and calculating the change in distance over that time. Alternatively, speed information could be gathered directly from a speedometer sensor 406. Other possible sensors that might be commonly located within the vehicle may be an RPM sensor 408, which could be used to generally gauge acceleration, steering wheel sensor 410, which could be used to gauge how much the vehicle is moving laterally, cruise control sensor 412, which may be used to gauge whether cruise control is engaged (which typically would imply a safer environment), brake sensor 414, which may be used to gauge whether the vehicle is currently braking, and traction control sensor 416, which may be used to gauge whether traction control is currently engaged (which typically would imply a less safe environment).

An accelerometer 418, such as those commonly found smartphones, could also be accessed.

Also presented are information sources 420-426 that may commonly be located outside of the vehicle, such as a mapping server 420, which may be used to determine how safe the current physical location is (e.g., a curvy mountain road may be less safe than a straight desert highway), weather server 422, which may be used to determine local weather conditions (e.g., is the vehicle located in a storm front), user profile database 424, which may store demographic information about the user (e.g., a driver), such as age, which could be useful in determining the relative safety level (e.g., a 16 year old driver or an 85 year old driver may require a “safer” user experience than a 40 year old driver), and an insurance database 426, which may contain information from an insurer of the vehicle, such as a safety record of the driver.

The dynamic user experience modification module 402 may be located in the vehicle, on a mobile device, or even on a separate server, such as a web server. The dynamic user experience modification module 402 may act to calculate a score identifying the relative safety level of the vehicle, based on one or more of the factors described above. This score may be compared with a series of thresholds to determine which of a number of different user experience modifications should be made. The thresholds may be stored in a table maintained in a data store 428.

A user experience presentation module 430 may receive the instructions for the updated user experience from the dynamic experience modification module 402 and update the user experience accordingly. This may take a number of forms, including the modification of a web page to be displayed in a browser, or the modification of visual or audio elements of an application user interface running in the vehicle.

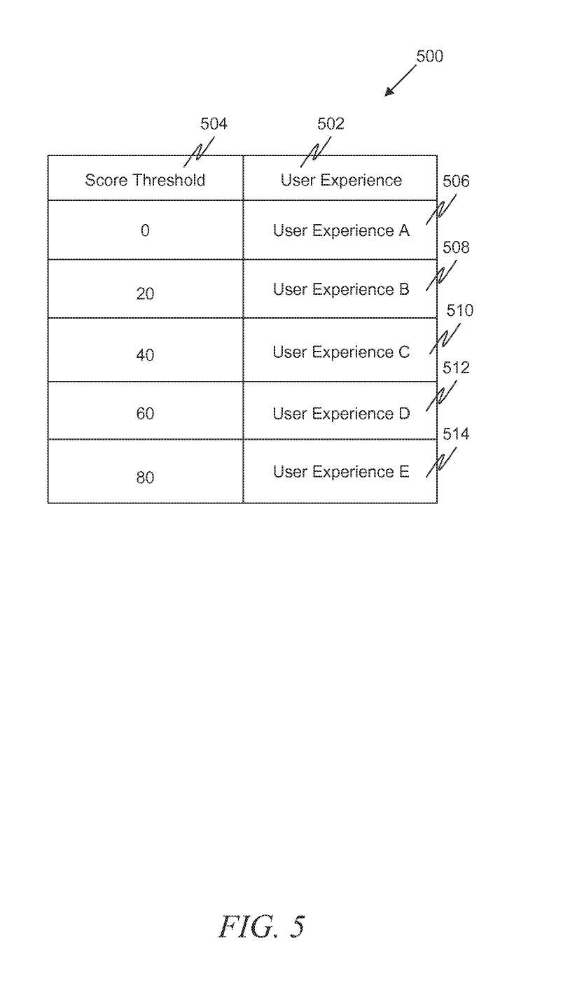

FIG. 5 is a diagram illustrating a table of user experience presentations in accordance with an example embodiment. The table 500 includes an identification of a user experience presentation in one column 502 and a score threshold in another column 504. As an example, the dynamic user experience modification module 402 may calculate a safety level score on a scale of 0-100. The table 500, therefore, identifies six different user experience presentations 506-514 each of which is used if the score is between the identified threshold and the next threshold. So if the dynamic user experience modification module 402 calculated a current safety level score of 56, then user experience C 510 would be utilized. If the situation changes to a less safe situation and the safety level score drops to 35, the table indicates that the user experience should be changed to user experience B 508.

It should be noted that while the above describes a single current safety level score applied based on one or more factors affecting the current safety level, the system could also be “forward-thinking” and calculate potential future changes to the current safety level and utilize such potential future changes in determining how to dynamically alter the user experience. This may involve, for example, calculating potential future safety level scores, or weighting (e.g., discounting or increasing) the current safety level score based on the future projections. For example, the system may determine that the current safety level score is a relatively safe 78, but that due to increased traffic ahead on the vehicle's route and projected weather information that the safety level may drop dramatically within a short time frame (e.g., within 5 minutes). As such, the relatively safe 78 score may be discounted so that the user experience presented is one that is designed for a less safe environment than if the 78 score were anticipated to continue for an extended period of time.

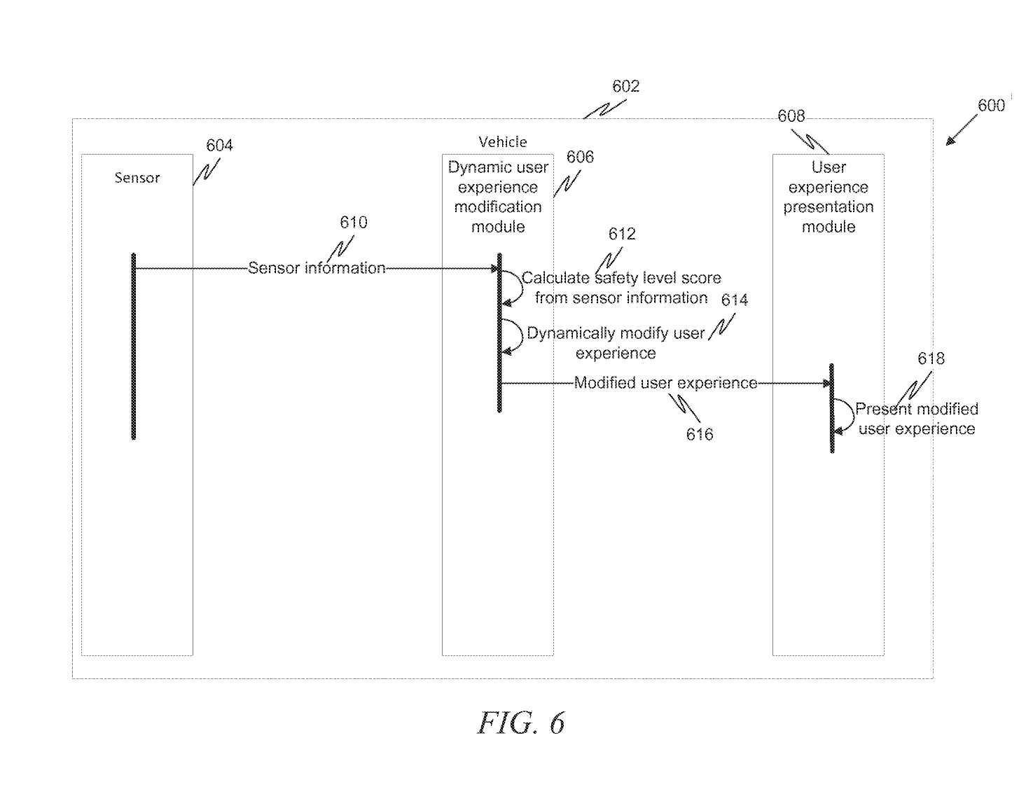

FIG. 6 is an interaction diagram illustrating a method 600, in accordance with an example embodiment, of dynamically altering a user experience. In this method 600, a vehicle 602 may contain a sensor 604, a dynamic user experience modification module 606, and a user experience presentation module 608. At operation 610, the sensor 604 sends sensor information to the dynamic user experience modification module 606. At operation 612, a safety level score is calculated from sensor information. At operation 614, a user experience is dynamically modified based on the safety level score. At operation 616, the dynamic user experience modification module 606 sends the modified user experience to the user experience presentation module 608, which at operation 618 presents the modified user experience.

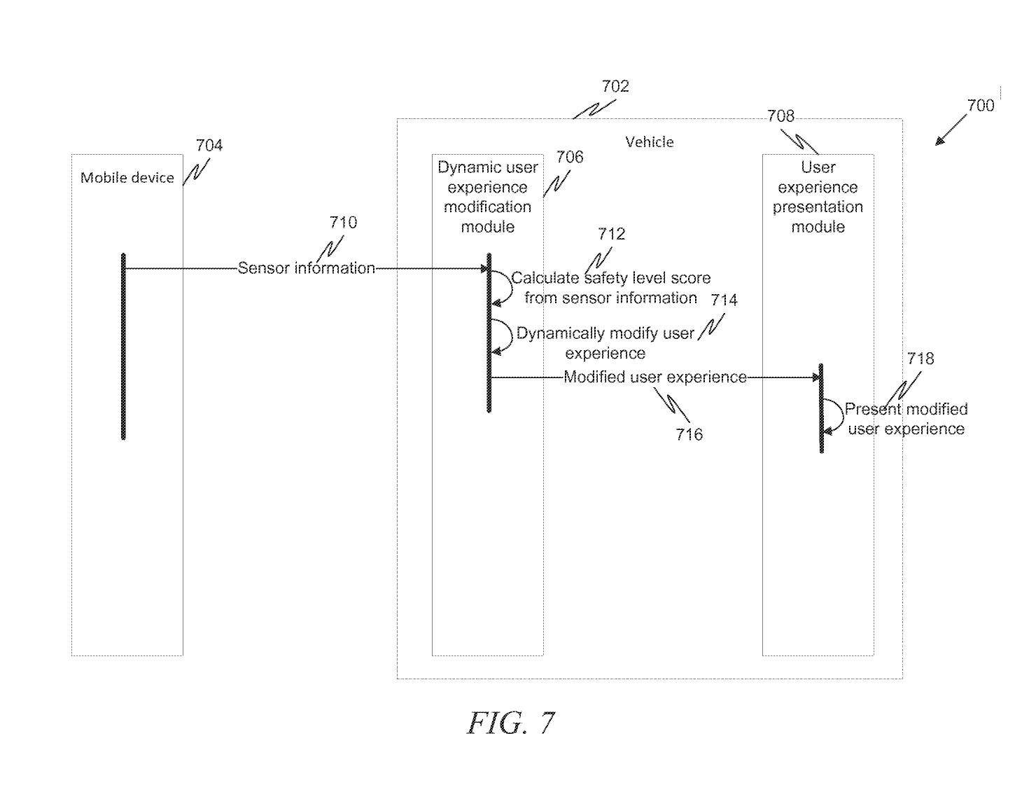

FIG. 7 is an interaction diagram illustrating a method 700, in accordance with another example embodiment, of dynamically altering a user experience. In this method 700, a mobile device 704, such as a smartphone, may contain a sensor, separate from a vehicle 702 itself, which contains a dynamic user experience modification module 706 and a user experience presentation module 708. At operation 710, the mobile device 704 sends sensor information to the dynamic user experience modification module 706. At operation 712, a safety level score is calculated from sensor information. At operation 714, a user experience is dynamically modified based on the safety level score. At operation 716, the dynamic user experience modification module 706 sends the modified user experience to the user experience presentation module 708, which at operation 718 presents the modified user experience.

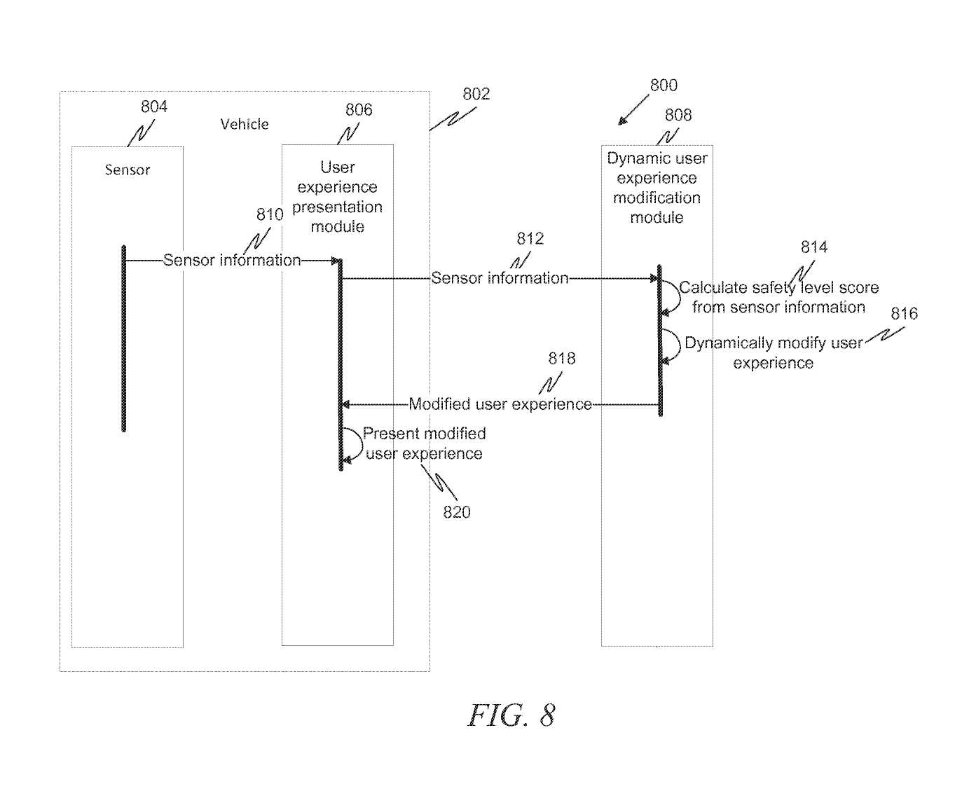

FIG. 8 is an interaction diagram illustrating a method 800, in accordance with another example embodiment, of dynamically altering a user experience. In this method 800, a vehicle 802 may contain a sensor 804 and a user experience presentation module 806. A dynamic user experience modification module 808 may be located elsewhere, such as on a server. At operation 810, the sensor 804 may send sensor information to the user experience presentation module 806, which at operation 812 may communicate the sensor information to the dynamic user experience modification module 808. This may be communicated by, for example, a wireless communications standard such as 3G, 4G, LTE, Wi-Fi, or any other wireless communication standard. At operation 814, a safety level score is calculated from sensor information. At operation 816, a user experience is dynamically modified based on the safety level score. At operation 818, the dynamic user experience modification module 808 sends the modified user experience to the user experience presentation module 806, which at operation 820 presents the modified user experience.

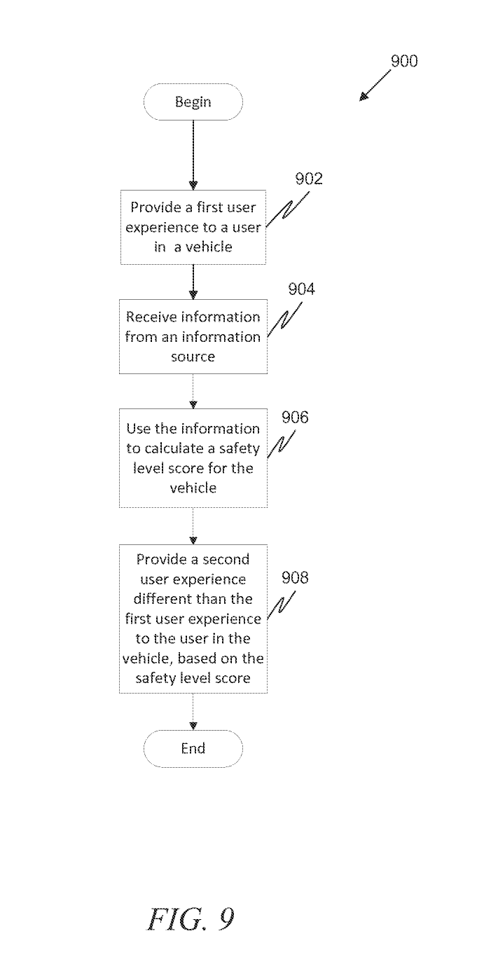

FIG. 9 is a flow diagram illustrating a method 900, in accordance with an example embodiment, of dynamically altering a user interface. At operation 902, a first user experience is provided to a user in a vehicle. At operation 904, information is received or retrieved from an information source. At operation 906, the information is used to calculate a safety level score for a vehicle. At 908, a second user experience different than the first user experience is provided to the user in the vehicle, based on the safety level score.

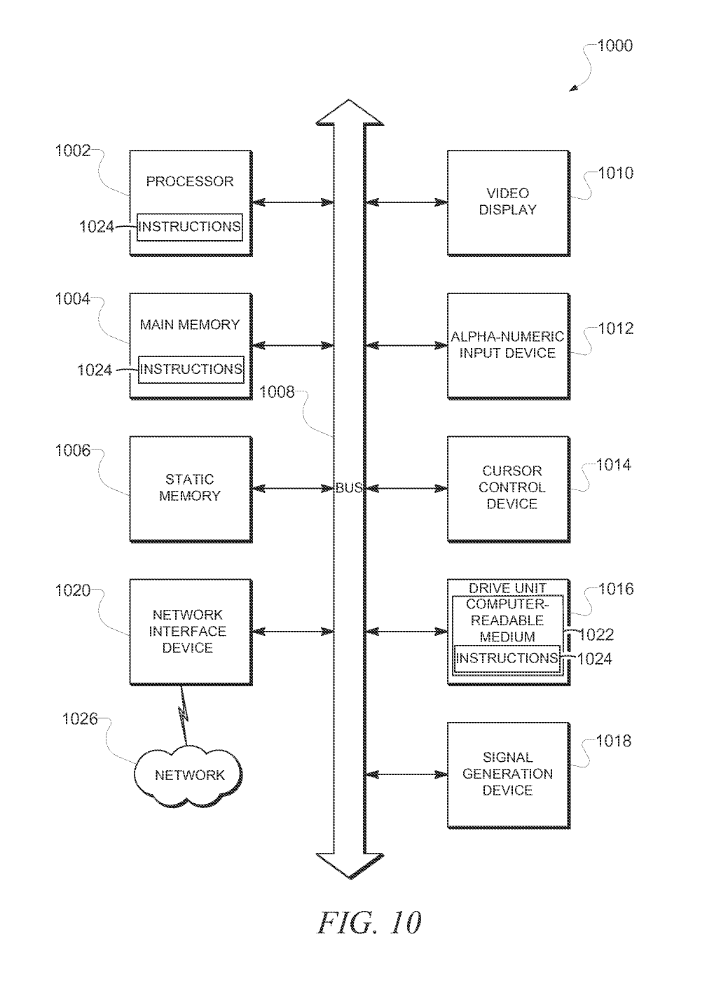

FIG. 10 shows a diagrammatic representation of a machine in the example form of a computer system within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker), and a network interface device 1020.

The disk drive unit 1016 includes a computer-readable medium 1022 on which is stored one or more sets of instructions 1024 (e.g., software) embodying any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting machine-readable media. The instructions 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions 1024. The term “machine-readable medium” shall also be taken to include any medium that is capable of storing, encoding or carrying a set of instructions for execution by the machine and that cause the machine to perform any one or more of the methodologies described herein. The term. “machine-readable medium” shall accordingly be taken to include, but not be limited to, solid-state memories, optical and magnetic media, and carrier wave signals.

Although the inventive concepts have been described with reference to specific example embodiments, it will be evident that various modifications and changes may be made to these embodiments without departing from the broader spirit and scope of the inventive concepts. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An electronic device, comprising:
a processor;
a dynamic user experience modification module configured to:
provide a first user experience to a user in a vehicle;
receive information from an information source;
use the information received from the information source to calculate a safety level score for a vehicle; and
causing a second user experience different than the first user
experience to be experienced by the user in the vehicle, based on the safety level score.

2. The electronic device of claim 1, wherein the electronic device is located in the vehicle.

3. The electronic device of claim 1, wherein the electronic device is a mobile device travelling in the vehicle.

4. The electronic device of claim 1, wherein the electronic device is a server in wireless communication with a user experience presentation module in the vehicle.

5. The electronic device of claim 1, wherein the information used to calculate the safety level score includes speed of the vehicle.

6. The electronic device of claim 1, wherein the information used to calculate the safety level score includes acceleration of the vehicle.

7. The electronic device of claim 1, wherein the information includes a map of a location of the vehicle.

8. The electronic device of claim 1, wherein the information used to calculate the safety level score includes weather at a location of the vehicle.

9. The electronic device of claim 1, wherein the information used to calculate a safety level score for a vehicle includes demographic information about a driver of the vehicle.

10. The electronic device of claim 1, wherein the information used to calculate a safety level score for a vehicle includes a driving safety record of the driver of the vehicle.

11. The electronic device of claim 1, wherein the second user experience removes selectable elements from a user interface based on the safety level score being lower than a safety level score corresponding to the first user experience.

12. The electronic device of claim 1, wherein the second user experience queues incoming notifications based on the safety level score being lower than a safety level score corresponding to the first user experience.

13. A method comprising:
providing a first user experience to a user in a vehicle;
receiving information from an information source;
using the information to calculate a safety level score for a vehicle; and
cause a second user experience different than the first user experience to be experienced by the user in the vehicle, based on the safety level score.

14. The method of claim 13, further comprising:
receiving further information from the information source;
using the further information to calculate a further safety level score for the vehicle; and
causing presentation of a third user experience different than either the first user experience and the second user experience on the interface in the vehicle, based on the further safety level score.

15. The method of claim 13, comprising modifying the safety level score based on predicted future changes to the safety level score based on information from another information source.

16. The method of claim 13, wherein the method is performed on a server in wireless communication with the vehicle.

17. The method of claim 13, wherein the method is performed in the vehicle.

18. The method of claim 13, wherein the user experience includes a web page.

19. A non-transitory computer-readable storage medium comprising instructions that, when executed by at least one processor of a machine, cause the machine to perform operations comprising:
providing a first user experience to a user in a vehicle;
receiving information from an information source;
using the information to calculate a safety level score for a vehicle; and
causing a second user experience different than the first user experience to be experienced by the user in the vehicle, based on the safety level score.

20. The non-transitory computer-readable storage medium of claim 19, wherein the operations further comprise queuing incoming notifications based on the safety level score being lower than a safety level score corresponding to the first user experience.
